(19) United States
(12) Patent Application Publication
(10) Pub. No.: US 2005/0272599 A1
(43) Pub. Date: Dec. 8, 2005

(54) Mold release layer

(76) Inventors: Kenneth Kramer, Corvallis, OR (US); Mark D. Johnson, Crovallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/860,865

(22) Filed: Jun. 4, 2004

(51) Int. Cl. B01J 27/135

(52) U.S. Cl. 502/227

(57) ABSTRACT

A mold release layer is provided, comprising the hydrosilylation reaction product between a hydrogen-terminated silicon surface and at least one compound selected from the group consisting of fluorinated terminal alkenes, fluorinated terminal alkynes, and mixtures thereof.

### BACKGROUND ART

Many nanometer scale imprint lithography processes require the use of an ultrathin release layer coating the mold. This mold release layer must be sufficiently free of defects such as pinholes and robust against thousands of cycles of imprinting, curing, and releasing. The process to create the release layer must be sufficiently reproducible, uniform, and particle free.

Current mold release layers described in the literature rely on reactions between species of the form R—Si—X₃, where R is an alkyl group (or more commonly a fluoroalkyl group) and X is typically Cl or OMe (OCH₃) or OEt (OC₂H₅). Of these reactants, trichlorosilanes are discussed most commonly.

The application of such silane mold release layers is typically done by (1) dip coating the molds into a solution (2) or vapor deposition of trichlorosilanes. However, these approaches tend to be problematic for one or more reasons, as noted below.

With dip coating of imprint molds into solutions of solvents (e.g., octane, hexane, heptane, 3M HFE7100) and trichlorosilanes, it is difficult to deposit films without particles. Additionally, unless used in a water free ambient, these solutions have a limited life, as they tend to absorb water from the atmosphere.

Vapor deposition of trichlorosilanes is the best solution, but can lead to films with poor uniformity.

There remains a need for a mold treatment that avoids most, if not all, of the foregoing problems.

### DISCLOSURE OF INVENTION

In accordance with the embodiments disclosed herein, a new class of mold release layers is provided that rely on the family of hydrosilylation reactions between a hydrogen-terminated silicon surface and at least one compound selected from the group consisting of fluorinated terminal alkenes, fluorinated terminal alkynes, and mixtures thereof.

In addition, a mold is provided for nanometer scale imprint lithography having the hydrogen-terminated silicon surface on which is formed the above-mentioned mold release layer.

Further, a method is provided for forming the mold release layer on the mold. The method comprises:
providing the mold having a silicon surface thereon;
creating a hydrogen-terminated surface on the silicon surface; and
forming the hydrosilylationsilation reaction product as above on the mold surface.

### BRIEF DESCRIPTION OF THE DRAWINGS

FIGS. 1a-1f depict an exemplary embodiment for coating the mold release layer on a mold for nanoimprinting.

### BEST MODES FOR CARRYING OUT THE INVENTION

Reference is made now in detail to specific embodiments, which illustrate the best modes presently contemplated by the inventors for practicing the invention. Alternative embodiments are also briefly described as applicable.

In accordance with the teachings herein, a new class of mold release layers is provided that rely on the family of hydrosilylation reactions between a hydrogen-terminated silicon surface and either a fluorinated alkene or a fluorinated alkyne.

Mold treatments described below may be carried out either on a thermal imprint mold (which can be opaque to UV and visible light and is often a silicon wafer) or on a step-and-flash imprint lithography (SFIL) mold (which is transparent to UV light and is often made of fused silica glass), although other molds may also be used.

In the case of a SFIL mold, the glass surface may need to be coated with a conformal, smooth, and ultrathin (˜5 nanometer (nm)) layer of silicon, preferably amorphous silicon, to allow the surface reaction to proceed.

Before subjecting the molds to the chemical treatment sequence described below, it is desirable to remove the thin layer of native SiO₂ and to create a hydrogen-terminated silicon surface by etching with a HF:NH₄F:H₂O solution (also called a buffered oxide etch, or BOE, solution). It may be beneficial to carry out this etch in a manner whereby only a single side of the mold is exposed to the etchant.

Now the samples are ready for chemical treatment by any of the procedures described below. In all cases, the hydrogen-terminated silicon surface is reacted with a fluorinated terminal alkene or alkyne.

Fluorinated terminal alkenes are given by the formula R₁—CX═CH₂, where R₁ is a fluorocarbon chain, preferably a perfluorinated carbon chain and X is H or F. An example of a fluorinated terminal alkene is 1H,1H,2H-perfluorodecene, which can be written as
CF₃CF₂CF₂CF₂CF₂CF₂CF₂CF₂CH═CH₂
or CF₃(CF₂)₇CH═CH₂
or C₁₀F₁₇H₃.

Fluorinated alkynes are given by the formula R₂—CH≡CH, where R₂ is a fluorocarbon chain, preferably a perfluorinated carbon chain. An example of a fluorinated alkyne is 1H-perfluorodecyne, which can be written as
CF₃CF₂CF₂CF₂CF₂CF₂CF₂CF₂C≡CH
or CF₃(CF₂)₇C≡CH
or C₁₀ F₁₇H.

The length of the fluorocarbon chain R₁ or R₂ is immaterial in the practice of the present embodiments. Note, however, that the end portion of the chain is terminated with a double bond (alkene) or triple bond (alkyne). In an alternate embodiment, the chain may include one or more additional carbon-carbon double or triple bonds, removed from the terminal double or triple bond. Such additional bond(s) may allow crosslinking between adjacent molecules, thereby creating a monolayer that is considerably more robust. An example is CF₃CF₂CF═CFCF₂CF₂CF₂CF₂C≡CH. The crosslinking reaction would be thermally driven at temperatures from 30° to 150° C. and times not to exceed, for example, 1 hour.

Essentially, the hydrogen portion of the hydrogen-terminated silicon surface reacts with the alkene and/or alkyne to produce an alkane or alkene, respectively. The reaction may be represented as
R₁—CH═CH₂+H-surface→R₁—CH₂—CH₂-surface
and
R₂—C≡CH+H-surface→R₂—CH═CH-surface
where “surface” is the silicon surface.

In one embodiment, a single fluorinated terminal alkene or a mixture of such alkenes, in which different R₁moieties are employed, may be used in the practice of the present teachings. In another embodiment, a single fluorinated terminal alkyne or a mixture of such alkynes, in which different R₂ moieties are employed, may be used. In yet another embodiment, a mixture of one or more fluorinated terminal alkenes and one or more fluorinated terminal alkynes may be used. In this last situation, the R₁ and R₂ moieties may be the same or different.

There are at least four procedures that may be used in the practice of the present embodiments. These are detailed below.

The first procedure is called light-stimulated hydrosilylation, or photosilylation, and is based on J. M. Stewart et al, “Photopatterned Hydrosilylation on Porous Silicon”, Angew. Chem. Int. Ed., Vol. 37, no. 23, pp. 3257-3260 (1998). An exemplary procedure is as follows:
(1) Expose the sample to either a vapor or a liquid solution containing a fluorinated terminal alkene or alkyne. If the solution route is taken and solvent is desired, the solvent may need to be fluorinated. Simple experimentation may be used to determine if the solvent needs to be fluorinated.
(2) Expose the sample to light. High fluxes of conventional halogen light spectrums have been used for this. Treatment times may be up to one hour or so depending on the incident flux. In one embodiment, the flux density employed may be up to 100 mW/cm², with exposure times of up to 30 min, or that which is necessary to complete the reaction. It may be necessary to cool the sample during exposure to the light to prevent it from boiling. Simple experimentation will determine if such cooling is necessary.
(3) Rinse the sample and repeat (starting at step 1) if desired.
(4) Rinse and sonicate the sample in an appropriate solvent to remove any noncovalently bonded absorbates. The parameters of sonication are not critical; a conventional laboratory ultrasonic cleaner, which operates at 40 KHz, has been found to be acceptable. A typical time of sonication is on the order of several minutes, but not, in general, exceeding about 10 minutes.
(5) Heat treat the sample if desired (optional) to complete crosslinking of adjacent molecules bonded to the surface. The crosslinking reaction can be driven by treatment at 30° to 150° C. for times not to exceed one hour.

The second procedure is called thermally-stimulated hydrosilylation, or thermal hydrosilylation, and is based on W. R. Ashurst, “Alkene based monolayer films as anti-stiction coatings for polysilicon MEMS”, Sens. & Actuators A, Vol. 91, pg. 239, 2001. An exemplary procedure is as follows:
(1) Expose the sample to either a vapor or a liquid solution containing a fluorinated terminal alkene or alkyne. If the solution route is taken and solvent is desired, the solvent may need to be fluorinated.
(2) Expose the sample to heat. Treatment times may be up to one hour or so depending on the temperature, which may range from about 40° to 100° C.
(3) Rinse the sample and repeat (starting at step 1) if desired.
(4) Rinse and sonicate the sample in an appropriate solvent to remove any non-covalently bonded absorbates. The conditions of sonnicating are as given above.
(5) Heat treat the sample if desired (optional) to complete crosslinking of adjacent molecules bonded to the surface. The crosslinking reaction can be driven by treatment at 30° to 150° C. for times not to exceed one hour.

The third procedure is called Lewis acid catalyzed reaction and is based on J. M. Buriak, “Lewis Acid Mediated Functionalization of Porous Silicon with Substituted Alkenes and Alkynes”, Journal of the American Chemical Society, Vol. 120, pp. 1339-1340 (1998). An exemplary procedure is as follows:
(1) Expose the sample to a liquid solution containing a fluorinated terminal alkene or alkyne and a Lewis acid catalyst, such as ethyl aluminum dichloride. The solvent may need to be fluorinated. Alternatively, it may be desired to sequentially expose the mold to first the Lewis acid solution followed by the fluorinated terminal alkene or alkyne solution. This might be required if the Lewis acid can react with the alkene or alkyne in solution.
(2) Rinse the sample and repeat (starting at step 1) if desired.
(3) Rinse and sonicate the sample in an appropriate solvent to remove any noncovalently bonded absorbates. The conditions of sonicating are as given above.
(4) Heat treat the sample if desired (optional) to complete crosslinking of adjacent molecules bonded to the surface. The crosslinking reaction can be driven by treatment at 30° to 150° C. for times not to exceed one hour.

The fourth procedure is called carbocation-initiated hydride abstraction and is based on J. M. Schmeltzer, “Hydride Abstraction Initiated Hydrosilylation of Terminal Alkenes and Alkynes on Porous Silicon”, Langmuir, Vol. 18, pp. 2971-2974 (2002). An exemplary procedure is as follows:
(1) Expose the sample to a liquid solution containing a fluorinated terminal alkene or alkyne and a hydride-extracting carbocation species, such as (C₆H₆)₃CBF₄. The solvent may need to be fluorinated. Alternatively, it may be desired to sequentially expose the mask to first the hydride extracting carbocation solution followed by the fluorinated terminal alkene or alkyne solution.
(2) Rinse the sample and repeat (starting at step a) if desired.
(3) Rinse and sonicate the sample in an appropriate solvent to remove any noncovalently bonded absorbates. The conditions of sonicating are as given above.
(4) Heat treat the sample if desired (optional) to complete crosslinking of adjacent molecules bonded to the surface. The crosslinking reaction can be driven by treatment at 30° -150° C. for times not to exceed one hour.

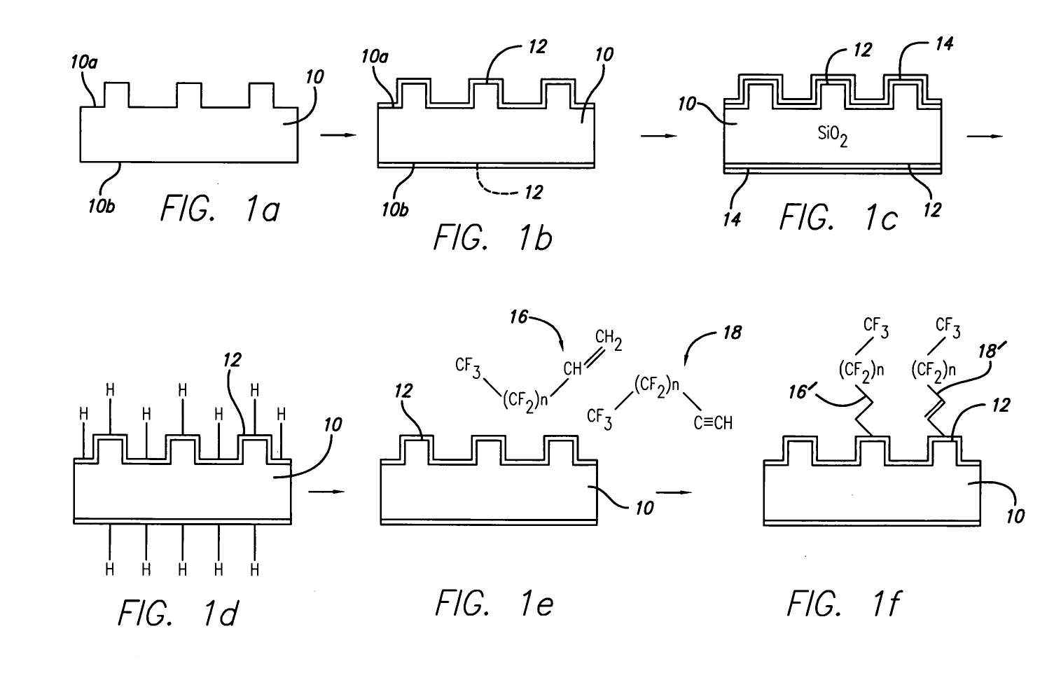

An embodiment of the present teachings is shown in the process sequence depicted in FIGS. 1a-1f. As shown in FIG. 1a, a silica (SiO₂) template, or mold, 10, preferably fused silica, is provided, having a front surface 10a and a back surface 10b. The silica template 10 is coated with an ultrathin film 12 of an amorphous silicon layer, typically about 5 nanometers (nm) thick, as shown in FIG. 1b. Coating of the back surface 10b is optional. A native oxide film 14 forms on the silicon film 12, as shown in FIG. 1c. The native oxide 14 is removed, such as by dipping the coated template 10 in a solution of NH₄F:HF at room temperature for about 30 sec. Such solutions for removing native SiO₂ are well known. The removal of the native oxide leaves a hydrogen-terminated silicon surface 12a everywhere that the native oxide has been removed, as shown in FIG. 1d. The hydrogen-terminated surface 12a is stable for about 30 min. The hydrogen-terminated surface 12a is exposed to one or more of the fluorinated alkyenes 16 and/or fluorinated alkynes 18 described above, as shown in FIG. 1e. The alkene and/or alkyne may be in either liquid or vapor form. Exposure of the coated template 10 to heat or light or chemistry, as described above, drives the reaction of the fluoroalkene and/or fluoroalkyne with the silicon surface 12, as described above and as shown in FIG. 1f.

The advantages of any of the foregoing approaches are:
fewer particles deposited on the mold;
greater reproducibility run-to-run;
improved mold release coating coverage within a run;
allows the possibility of subsequent chemical reactions at double bonds in fluroalkene or fluoroalkyne; and
hydrosilylation reactions should be easier to control than trichlorosilane reactions. Trichlorosilane reactions with SiO₂ surfaces are difficult to control because they rely on water to hydrolyze the Si—Cl bond. Without water, the reaction proceeds exceptionally slowly. On the other hand, once hydrolyzed, silanes can polymerize, leading to the formation of particles or uncontrolled thicknesses greater than a single monolayer.

The release layer formed by hydrosilylation reactions may be more robust because of increased coverage (areal density) of the alkenes or alkynes compared with trifunctional silanes. Increased coverage would be expected in cases where the coverage is limited by steric hindrance of the ligands on the silicon atom and not by the orientation of the alkyl end group. For example, for reaction between a R—CH═CH₂ surface and an alkene, only hydrogen atoms need to fit between the neighboring chains. However, for reactions between R—Si—(CH₃)₂CI and the SiO₂ surface, there are two methyl groups that must fit between each alkyl molecule.

The chemistry of hydrosilylation allows more flexibility than that of reactions with silanes. Numerous means of driving the hydrosilylation reaction have been published by others, including light stimulated reactions, thermally stimulated reactions, Lewis acid catalysis, and treatment with hydride-abstracting carbocations, as described above.

Hydrosilylation with alkynes will leave an unsaturated molecule bonded to the surface, which might be useful for subsequent chemical reactions to crosslink neighboring molecules.

### INDUSTRIAL APPLICABILITY

The mold release agent is expected to find use in nanometer scale imprint lithography.

1. A mold release layer comprising the hydrosilylation reaction product between a hydrogen-terminated silicon surface and at least one compound selected from the group consisting of fluorinated terminal alkenes, fluorinated terminal alkynes, and mixtures thereof.

2. The mold release layer of claim 1 wherein said at least one fluorinated terminal alkene is represented by the formula R₁—CX═CH₂, where R₁ is a perfluorinated alkyl group, optionally including at least one unsaturated bond, and where X is H or F.

3. The mold release layer of claim 1 wherein said at least one fluorinated terminal alkyne is represented by the formula R₂—C≡CH, where R₂ is a perfluorinated alkyl group, optionally including at least one unsaturated bond.

4. The mold release layer of claim 1 wherein said at least one fluorinated terminal alkene is represented by the formula R₁—CH═CH₂, where R₁ is a perfluorinated alkyl group, and wherein said at least one fluorinated terminal alkyne is represented by the formula R₂—CH≡CH, where R₂ is a perfluorinated alkyl group, where R₁ is the same as or different than R₂.

5. A mold for nanometer scale imprint lithography having a silicon surface and provided with a mold release layer comprising the hydrosilylation reaction product between a hydrogen-terminated silicon surface and at least one compound selected from the group consisting of fluorinated terminal alkenes, fluorinated terminal alkynes, and mixtures thereof.

6. The mold of claim 5 wherein said mold comprises silicon, thereby providing said silicon surface.

7. The mold of claim 5 wherein a layer of silicon is formed on said mold, thereby providing said silicon surface.

8. The mold of claim 5 wherein said at least one fluorinated terminal alkene is represented by the formula R₁—CX═CH₂, where R₁ is a perfluorinated alkyl group, optionally including at least one unsaturated bond, and X is H or F.

9. The mold of claim 5 wherein said at least one fluorinated terminal alkyne is represented by the formula R₂—C≡CH, where R₂ is a perfluorinated alkyl group, optionally including at least one unsaturated bond.

10. The mold of claim 5 wherein said at least one fluorinated terminal alkene is represented by the formula R₁—CH═CH₂, where R₁ is a perfluorinated alkyl group, and wherein said at least one fluorinated terminal alkyne is represented by the formula R₂—CH≡CH, where R₂ is a perfluorinated alkyl group, where R₁ is the same as or different than R₂.

11. The mold of claim 5 wherein said mold is a thermal imprint mold.

12. The mold of claim 11 wherein said mold comprises a silicon wafer.

13. The mold of Clam 5 wherein said mold is a step and flash imprint lithography mold.

14. The mold of claim 13 wherein said mold comprises fused silica glass.

15. The mold of claim 14 wherein a surface of said fused silica glass is coated with a layer of silicon.

16. The mold of claim 15 wherein said layer of silicon comprises amorphous silicon.

17. A method of forming a mold release layer on a mold for nanometer scale imprint lithography, said method comprising
providing said mold having a silicon surface thereon;
creating a hydrogen-terminated surface on said silicon surface; and
forming a hydrosilylation reaction product by reacting said hydrogen-terminated silicon surface on said mold with at least one compound selected from the group consisting of fluorinated terminal alkenes, fluorinated terminal alkynes, and mixtures thereof to thereby form said mold release layer comprising said hydrosilylation reaction product.

18. The method of claim 17 wherein said at least one fluorinated terminal alkene is represented by the formula R₁—CX═CH₂, where R₁ is a perfluorinated alkyl group, optionally including at least one unsaturated bond, and X is H or F.

19. The method of claim 17 wherein said at least one fluorinated terminal alkyne is represented by the formula R₂—C≡CH, where R₂ is a perfluorinated alkyl group, optionally including at least one unsaturated bond.

20. The method of claim 17 wherein said at least one fluorinated terminal alkene is represented by the formula R₁—CH═CH₂, where R₁ is a perfluorinated alkyl group, and wherein said at least one fluorinated terminal alkyne is represented by the formula R₂—CH≡CH, where R₂ is a perfluorinated alkyl group, where R₁ is the same as or different than R₂.

21. The method of claim 17 wherein said mold is a thermal imprint mold.

22. The method of claim 21 wherein said mold comprises a silicon wafer.

23. The method of clam 17 wherein said mold is a step and flash imprint lithography mold.

24. The method of claim 23 wherein said mold comprises fused silica glass.

25. The method of claim 24 wherein a surface of said fused silica glass is coated with a layer of silicon.

26. The method of claim 25 wherein said layer of silicon comprises amorphous silicon.

27. The method of claim 17 wherein said hydrogen-terminated silicon surface is created by etching said silicon surface with a buffered oxide etch.

28. The method of claim 27 wherein said buffered oxide etch comprises a solution of HF, NH₄F, and water.

29. The method of claim 17 wherein said hydrogen-terminated silicon surface is reacted with said at least one compound by light-stimulated hydrosilylation, thermally-stimulated hydrosilylation, Lewis acid catalyzed reaction, or carbocation-initiated hydride abstraction.

30. The method of claim 29 wherein said light-stimulated hydrosilylation is performed by the steps of:
exposing said hydrogen-terminated silicon surface of said mold to either a vapor or a liquid solution containing a fluorinated terminal alkene or alkyne;
exposing said silicon surface to light;
rinsing said silicon surface and optionally repeating at least one of the preceding steps at least once;
rinsing and sonicating said silicon surface in an appropriate solvent to remove any non-covalently bonded absorbates; and
optionally, heat-treating said silicon surface to crosslink adjacent molecules bonded to said silicon surface.

31. The method of claim 30 wherein said liquid solution is employed, comprising a solution of said fluorinated terminal alkene or alkyne in a fluorinated solvent.

32. The method of claim 30 wherein said exposing to light is performed using a flux of up to 100 mW/cm² for a period of time of up to 30 minutes.

33. The method of claim 29 wherein said thermally stimulated hydrosilylation is performed by:
exposing said silicon surface to either a vapor or a liquid solution containing a fluorinated terminal alkene or alkyne;
exposing said silicon surface to heat;
rinsing said silicon surface and optionally repeating at least one of the preceding steps at least once;
rinsing and sonicating said silicon surface in an appropriate solvent to remove any non-covalently bonded absorbates; and
optionally, heat-treating said silicon surface to crosslink adjacent molecules bonded to said silicon surface.

34. The method of claim 33 wherein said liquid solution is employed, comprising a solution of said fluorinated terminal alkene or alkyne in a fluorinated solvent.

35. The method of claim 33 wherein said exposing to heat is performed using a temperature of 40° to 100° C. for a period of time of up to one hour.

36. The method of claim 29 wherein said Lewis acid catalyzed reaction is performed by:
exposing said silicon surface to a liquid solution containing a fluorinated terminal alkene or alkyne and a Lewis acid catalyst;
rinsing said silicon surface and optionally repeating the preceding step at least once;
rinsing and sonicating said silicon surface in an appropriate solvent to remove any noncovalently bonded absorbates; and
optionally, heat-treating said silicon surface to crosslink adjacent molecules bonded to said silicon surface.

37. The method of claim 36 wherein said liquid solution comprises a solution of said fluorinated terminal alkene or alkyne in a fluorinated solvent.

38. The method of claim 36 wherein said exposing step is performed by sequentially exposing said silicon surface to a first liquid solution comprising said Lewis acid catalyst followed by exposing said silicon surface to a second liquid solution comprising said fluorinated terminal alkene or alkyne in solution.

39. The method of claim 29 wherein said carbocation-initiated hydride abstraction is performed by:
exposing said silicon surface to a liquid solution containing a fluorinated terminal alkene or alkyne and a hydride-extracting carbocation species;
rinsing said silicon surface and optionally repeating the preceding step at least once;
rinsing and sonicating said silicon surface in an appropriate solvent to remove any noncovalently bonded absorbates; and
optionally heat-treating said silicon surface to crosslink adjacent molecules bonded to the surface.

40. The method of claim 39 wherein said liquid solution comprises a solution of said fluorinated terminal alkene or alkyne in a fluorinated solvent.

41. The method of claim 39 wherein said exposing step is performed by sequentially exposing said silicon surface to a first liquid solution comprising said hydride extracting carbocation solution followed by exposing said silicon surface to a second liquid solution comprising said fluorinated terminal alkene or alkyne in solution.
